(19) United States
(12) Patent Application Publication
(10) Pub. No.: US 2007/0221278 A1
(43) Pub. Date: Sep. 27, 2007

(54) Flow Interrupter for a Liquid or Gaseous Fluid Flow Pipe

(75) Inventor: Thierry Sartorius, Hardelot (FR)

Correspondence Address: YOUNG & THOMPSON, 745 SOUTH 23RD STREET, 2ND FLOOR, ARLINGTON, VA, 22202, US

(73) Assignee: HYDRELIS, LILLE (FR)

(21) Appl. No.: 11/579,316

(22) PCT Filed: May 13, 2005
(86) PCT No.: PCT/FR05/01200

§ 371 Date: Nov. 1, 2006

(30) Foreign Application Priority Data
May 14, 2004 (FR) 04 05265

(51) Int. Cl. F16K 11/02

(52) U.S. Cl. 137/870

(57) ABSTRACT

In the flow interrupter of the invention, mechanical members (4) for interrupting the flow of a fluid in a pipe (3a, 3b) are housed together with drive elements (6, 7) therefore in a leaktight body (2). Electrical and electronic control elements for controlling the drive elements are supported by a support (11) that is separate from the body (2) and that is fitted thereto by a simple assembly operation. The invention is applicable to the field of providing safety for fluid pipes.

The invention relates to a safety device constituting a flow interrupter for a pipe conveying a flow of a fluid that is liquid or gaseous.

### BACKGROUND OF THE INVENTION

Numerous methods and devices exist for detecting a flow of fluid in a pipe in order to measure it in order to meter consumption, to monitor normal behavior relative to a model for the flow (whether in terms of flow rate, or flow duration, or total volume, . . . ), and to interrupt flow in the pipe by means of a closure member in the event of an abnormality occurring (most frequently a sign of a leak from the pipe).

All prior art devices make use of a processor unit for interpreting a signal delivered by a direct or indirect sensor of the flow rate of the fluid in the pipe, the unit including software run on a microcomputer or a microcontroller, which software can be configured by the user. In general, the electronic portion of such devices includes a display for displaying measured values of volume or flow rate concerning the fluid flow in the pipe, and a member for issuing an alarm in the event of critical values being reached. In parallel with such alarm members, some devices also include members for interrupting flow in the pipe, usually constituted by solenoid valves, i.e. valves under electrical control, with the power supply being taken from a network to which the solenoid valve is connected. One example of that prior art is described in French patent document FR-2 690 525.

Prior to the present invention, proposals have also been made to provide a flow interrupter that is timed, for the purpose of interrupting a flow of abnormally long duration, a sign that an installation is malfunctioning. German patent document DE 28 05 908 discloses an entirely mechanical embodiment of such a flow interrupter that nevertheless presents limits on its use, which limits relate in particular to implementing springs having characteristics that vary over time. That document also describes another embodiment in which a spinner is actuated by the fluid flowing in the pipe, the spinner issuing a signal to a power supply unit connected to the electricity power supply network, e.g. in a house, and capable of driving a solenoid valve. The advantage of that version lies in the possibility of monitoring more finely and thus of triggering the flow interrupter in response to a wider variety of causes.

Mention can finally be made of French patent document FR 2 646 234 which describes a device that combines a meter and a controlled valve connected by a remote metering and control system to an organization for managing fluid consumption.

### OBJECT AND SUMMARY OF THE INVENTION

The invention seeks to provide a flow interrupter function for a fluid flow pipe by means of a device that is suitable for domestic use and that possesses simultaneously the simplicity in operation of a version that is entirely mechanical, together with the breadth of potential triggering conditions of an electromagnetic version, but without presenting the drawbacks of either of them.

To this end, the invention thus provides a flow interrupter for a pipe for conveying a liquid or gaseous fluid, the interrupter comprising:

a flow rate detector chamber with an inlet orifice, an outlet orifice, and a spinner situated between said two orifices;

a closure member for closing at least one of the two orifices of the detector chamber, the closure member being movable between a first position in which the pipe is open and a second position in which it is closed;

means including a lever for driving the closure member to cause it to move between its positions, and means for holding the member in each of its positions;

a detector for detecting rotation of the said spinner by emitting an electrical signal representative of the magnitude of at least one parameter of said rotation; and

electronic means for interpreting said signal and forming means for canceling the effect of a magnetic holder for holding the manual control lever of the closure member in its closure position, in which flow interrupter, firstly the detector chamber and the closure member are contained in a leaktight body possessing means enabling it to be inserted in a fluid flow pipe, and secondly the detector for detecting rotation of the spinner, the electronic means for interpreting the signal, and the magnetic holder with a winding for canceling its permanent magnetic field are secured to a support to form a separate unit that is fitted on a surface of the body, which unit also includes a power supply for feeding electricity to the winding and the electronic means.

In addition to the above-specified advantages, this disposition is particularly easy to maintain since the two families of components, the mechanical components and the electrical components are completely separate and are accessed independently.

In an embodiment of the invention, the said support is a plane plate, the body having a plane outside surface on which said plate is secured, which surface is perpendicular to the axis of the spinner housed in the detector chamber.

In this embodiment, the body and the support are surmounted by a covering cap fitted on the body. Finally, in a variant, the support and the cap are secured to each other and together form a housing that is fitted on the said body.

### BRIEF DESCRIPTION OF THE DRAWINGS

Other characteristics and advantages of the invention appear from the description given below of an embodiment thereof.

Reference is made to the accompanying drawing, in which:

FIG. 1 is an outside view of the flow interrupter of the invention; and

FIG. 2 is a fragmentary view of the flow interrupter emphasizing the means that are specific to the invention.

### MORE DETAILED DESCRIPTION

With reference to the figures, it can be seen that the flow interrupter 1 of the invention comprises a lower, substantially rectangular body 2 that is suitable for inserting in series in a fluid flow pipe between two segments 3a and 3b thereof. In conventional manner, inside the body 2, the pipe opens out into a detector chamber 3 for detecting the rate of fluid flow in the pipe. As in any water or gas meter, the detector chamber 3 includes a spinner (not shown) of axis T, and rotation of the spinner is detected in order to obtain a signal representative of fluid flowing in the pipe 3a, 3b. By way of example, the spinner may carry a permanent magnet which, on rotation, passes in front of a suitable detector (flexible blade switch, electromagnetic cell, . . . ) or a winding of a current generator.

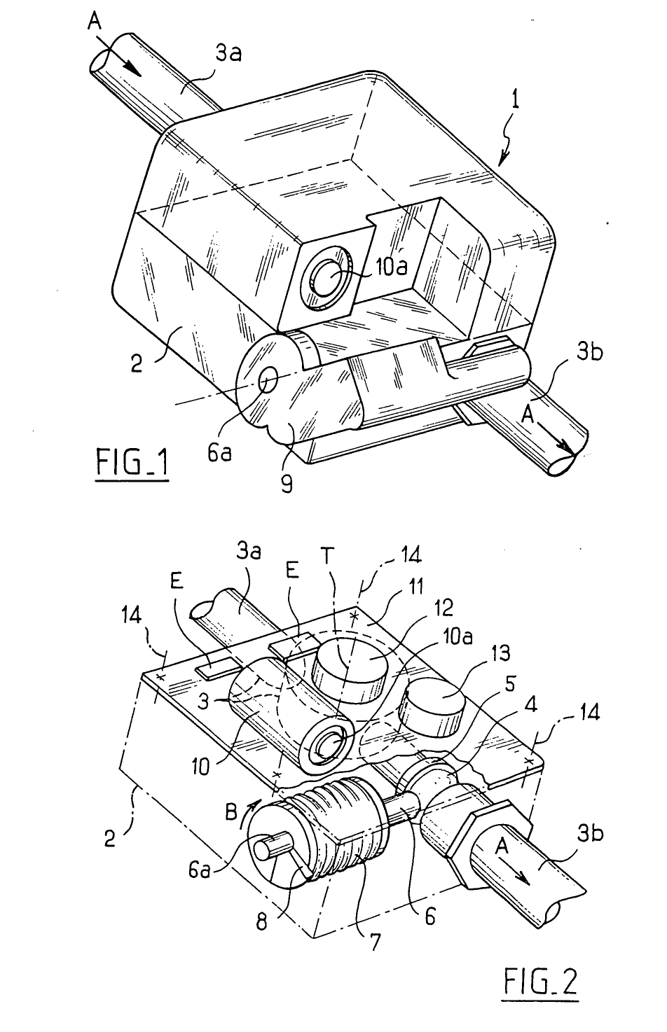

In accordance with the invention, the body 2 also has a closure member, constituted in this example essentially by a spherical plug 4, located in this example at the outlet 5 from the detector chamber 3 in the direction A in which the fluid flows along the pipe. This spherical plug 4, that is shown in FIG. 2 in its position in which it opens the pipe, is driven by means of a rotary key 6 that extends perpendicularly to the pipe 3a, 3b and that is accessible at one end 6a from outside the body 2. This key 6 is continuously subjected to bias from a helical spring 7, also received in the body 2, and urging it towards its pipe-closure position, i.e. urging it to turn the plug 4 through one-fourth of a turn in the clockwise direction referenced B in FIG. 2. At its end 6a, the key 6 possesses means 8 for angularly engaging a lever 9 for driving the key, which lever is shown in FIG. 1 in an intermediate position close to its position for closing the closure member 4.

The lever 9 extends outside the body 2 so as to be accessible to an operator. It constitutes a member for manually driving the spherical plug 4 from its closure position to its position in which it opens the pipe 3, against the force of the return spring 7 tending to hold the closure member 4 in the closed position by forcing the key 6 against a bearing surface of the body 2 (surface not shown).

On a face that is not visible in FIG. 1, the lever 9 carries a pellet of ferromagnetic material which, when the lever is returned in the opposite direction to the above-specified direction B, comes into contact with the active face 10a of a magnetic holder 10. The magnetic holder is constituted in conventional manner by a permanent magnet and has around the permanent magnet a winding which, when it carries the current, generates magnetic flux for canceling the permanent magnetic flux of the magnet. When the flux is canceled in this way, the lever 9 is no longer held in the plug-open position, and under the effect of the spring 7 it tilts in the direction B, while the key 6 turns simultaneously in the same direction and the plug closes the pipe.

In FIG. 2, it can be seen that the holder 10 is secured to a support 11, in this case a plane plate fitted on a corresponding plane surface of the body 2. This surface is advantageously perpendicular to the axis T of the spinner. In register with the detector chamber 3 (above it), the plate 11 presents a detector 12 for detecting rotation of the spinner contained in the chamber. The detector 12 may advantageously be constituted by a current generator. It may equally well be of some other kind, for example it could be a flexible blade switch that responds through a non-magnetic top wall of the body 2, to a magnet that is secured to the top portion of the spinner so as to open or close an electric circuit and generate pulses representative of spinner rotation.

The plane support 11 may advantageously be constituted by or include a printed circuit having electronic components E mounted thereon that are suitable for interpreting the signals from the spinner and for processing them in such a manner as to cause a circuit for driving the canceling winding of the magnetic holder as a function of a prerecorded program (an application specific integrated circuit (ASIC)) or as a function of a programmable microcontroller. Closure of the circuit is extremely brief, sufficing to deliver a magnetic pulse opposing the permanent field of the holder, which pulse should be of a duration that is sufficient to allow the lever to move away from the holder under drive from the spring 7. Under such conditions, the electricity consumption of the device of the invention is extremely low, and the power supply needed by the interrupter can be constituted by a battery 13 that also rests on the support 11. When the detector 12 is the winding of a current generator, the battery 13 can be a rechargeable battery.

By means of this architecture, it can be understood that the mechanical and hydraulic components are entirely independent of the electrical and electronic components. Each of these two portions of the interrupter can be manufactured independently of the other. The complete flow interrupter can be made merely by assembling the support 11 that forms a unit with the body 2 by means of assembly members as represented diagrammatically at 14.

Naturally, for reasons of appearance, the assembly should be finished off by a cover of the kind shown in FIG. 1, which cover may also include a portion of the body 2, or in another embodiment, the support 11 and a cap 15 can be assembled to each other and the resulting unit can be fitted onto the body 2 by fastener elements, e.g. accessible from the bottom face of the body 2 that is not shown in the figures.

As with any electrical circuit that consumes little energy, the flow interrupter of the invention may include an indicator of the level of charge in the battery 3 in order to warn the user and provide information about said level of charge.

1-6. (canceled)

7. A flow interrupter for a pipe (3a, 3b) for conveying a liquid or gaseous fluid, the interrupter comprising:
a flow rate detector chamber (3) with an inlet orifice, an outlet orifice (5), and a spinner situated between said two orifices;
a closure member (4) for closing at least one (5) of the two orifices of the detector chamber, the closure member (4) being movable between a first position in which the pipe (3a, 3b) is open and a second position in which it is closed;
means (6, 7, 9) including a lever (9) for driving the closure member (4) to cause it to move between its positions, and means for holding the member (4) in each of its positions;
a detector (12) for detecting rotation of the said spinner by emitting an electrical signal representative of the magnitude of at least one parameter of said rotation; and
electronic means (E) for interpreting said signal and forming means for canceling the effect of a magnetic holder (10) for holding the manual control lever (9) of the closure member (4) in its closure position;
the flow interrupter being characterized in that:
the detector chamber (3) and the closure member (4) are contained in a leaktight body (2) possessing means enabling it to be inserted in a fluid flow pipe (3a, 3b), and in that the detector (12) for detecting rotation of the spinner, the electronic means (E) for interpreting the signal, and the magnetic holder (10) with a winding for canceling its permanent magnetic field are secured to a support (11) to form a separate unit fitted on a surface of the body (2), which unit also includes a power supply (13) for feeding electricity to the winding and the electronic means.

8. A flow interrupter according to claim 7, characterized in that the said support (11) is a plane plate, the body (2) having a plane outside surface on which said plate is secured, which surface is perpendicular to the axis of the spinner (T) housed in the detector chamber.

9. A flow interrupter according to claim 7, wherein the body (2) and the support (11) are surmounted by a covering cap (15) fitted on the body.

10. A flow interrupter according to claim 9, wherein the support and the cap are secured to each other and together form a housing that is fitted on the said body (2).

11. A flow interrupter according to claim 7, wherein the power supply source is a battery (13).

12. A flow interrupter according to claim 10, wherein the power supply comprises a current generator associated with the battery (13) that is rechargeable.
